(19) United States
(12) Patent Application Publication
(10) Pub. No.: US 2002/0070647 A1
(43) Pub. Date: Jun. 13, 2002

(54) Nanostructure plasma source

(76) Inventors: Andrey Ginovker, Toronto (CA); Darek Molenda, Caledon (CA); Vladimir Cherepanov, Toronto (CA)

Correspondence Address: EUGENE J A GIERZAK, KEYSER MASON BALL, 201 CITY CENTRE DRIVE, SUITE 701, MISSISSAUGA, ONTARIO, L5B 2T4, CA

(21) Appl. No.: 10/011,403

(22) Filed: Dec. 11, 2001

Related U.S. Application Data
(60) Provisional application No. 60/254,172, filed on Dec. 11, 2000.

(51) Int. Cl. H01J 17/26

(52) U.S. Cl. 313/231.41

(57) ABSTRACT

An arc source macroparticle filter comprising a cathode for emitting particles, an anode for accelerating said emitted particles, means for generating a magnetic field to form magnetic walls to deflect and guide curved plasma stream for directing ions toward a substrate and separate therefrom undesirable macroparticles.

### FIELD OF THE INVENTION

This invention relates to cathodic vacuum arc deposition and in particular relates to filtered cathodic vacuum arc deposition.

### BACKGROUND OF THE INVENTION

Cathodic arc deposition has been used heretofore to deposit films unto various substrates. Generally speaking cathodic arc apparatus generally includes a vacuum chamber which contains a relatively small amount of gas. A negative lead of direct current power source is usually applied to the cathode or source material and the positive lead is attached to an anodic member such as for example the deposition chamber itself. An arc-igniting trigger is utilized to generate an arc between the cathode and anodic chamber. Generally speaking the point where an arc touches the surface of the cathode is referred to as a cathode spot. As a result cathode material at the cathode spot vaporizes into plasma containing atoms, molecules, ions, electrons and particles. The stream of plasma flows away from the surface of the cathode and is deposited unto the substrate forming a coating thereon.

Generally speaking the films deposited by the high-energy plasma source have good nanocrystal structure, high density and hardness and low structural defect concentration; and as a result have good diffusion barrier properties with minimum thickness.

Filtered cathodic vacuum arc deposition is one of the most productive and least expensive methods among nanostructure film deposition technologies. However, this method has limited applications particularly in the electronics and optical areas because it is not completely free from metal macroparticles.

Cathodic arc deposition generates droplets of metal i.e. macroparticles along with the metal ion plasma.

One difficulty associated with cathodic arc deposition is the generation of macroparticles which are particles emitted from the cathode with sizes ranges from several atomic sizes of for example between 0.1 microns up to 50 microns in size. Macroparticles tend to cause surface irregularities in the deposited coating by becoming permanently embedded or temporarily affixed to the coating and later detaching. Accordingly macroparticles result in undesirable nonuniformities which make the coatings unsuitable for particular mechanical, electronic and optical applications.

Various methods have heretofore been devised and described in order to attempt to remove the macroparticles from the cathodic arc plasma.

It is known that macroparticles generated in the hot spot on the surface of a cathode are injected with very high velocity into the plasma stream and bounce from the cold walls of the magnetic duct and finally a part of those macroparticles arrive at the surface of a substrate.

For example Andre Anders in “Surface and Coatings Technology” 120-121 (1999) 319-330 wrote an article entitled Approaches to Rid Cathodic Arc Plasma of Macro and Nano Particles: A Review, which describes particle filters that have heretofore, been used to separate and remove particles from the cathodic arc plasma. Generally speaking Anders describes:

(a) a straight magnetic filter which improves the plasma to particle ratio but does not eliminate particles completely because there is a line of sight between the cathode and substrate;

(b) a classic 90° duct filter which includes a 90° duct consisting of a curved tube which is surrounded by a magnetic field coil generating a curved axial field which includes baffles in the duct to remove the macroparticles;

(c) knee filters which have a relatively small bent angle;

(d) S-shaped duct filters that include a duct surrounded by a magnetic field;

(e) a free standing 90° filter where there is no duct (i.e continuous walls forming the ducts) present and the magnetic field is produced by only a few turns of field coil where particles may either leave the filter through the openings between the turns of the field coil stick to the turns, or reflect off the turns;

(f) a free standing S-filter which includes a free standing S-filter without a duct i.e. walls.

It is known that macroparticles generated in the hot spot on the surface of a cathode are injected with very high velocity into the plasma stream and bounce from the cold walls of the magnetic duct and finally a part of those macroparticles arrive at the surface of a substrate.

Anders states that although the classic 90° duct filter is most widely used, the problem of particle reflection or bouncing is insufficiently addressed in the prior art. Anders stated that there is still a non-negligible probability that a particle is transmitted through the filter, although there is no direct line of sight. Free standing or open architectures improve the situation where there is no duct present and the magnetic field is produced by only a few turns of a field coil. Particles may either leave the filter through the openings between the turns of the field coil or stick to the turns. Unfortunately Anders states that there is still a small but non-zero probability that a particle will be reflected from a turn of the coil exactly in the direction of the substrate, and therefore even free standing filters do not guarantee completely particle free film deposition.

The freestanding open-architecture filter proposed by Anders is utilized for low temperature deposition of electrically conductive metal oxide.

Accordingly other cathodic arc metal deposition apparatus and methods have heretofore being devised. For example U.S. Pat. No. 5,317,235 teaches a cathodic arc metal deposition apparatus where the cathode has an annular configuration and an annular solenoidal magnet is positioned adjacent to the cathode with their central openings in alignment. The opening diameters and spacing of the cathode and magnet is such that no line of sight exists between the cathode and target to be coated.

Furthermore U.S. Pat. No. 5,902,462 teaches a filtered cathodic deposition method and apparatus for the production of highly dense, wear resistant coatings where the apparatus includes a cross shaped vacuum chamber which houses a cathodic target having an evaporable surface comprising of the coating material, means for generating a stream of plasma, means for generating a transverse magnetic field, and a macroparticle deflector. The transverse magnetic field bends the generated stream of plasma in the direction of a substrate. Macroparticles are effectively filtered from the stream of plasma by travelling unaffected by the transverse magnetic field, along the initial path of the plasma stream to a macroparticle deflector. The macroparticle deflector has a preformed surface, which deflects macroparticles away from the substrates.

Furthermore U.S. Pat. No. 5,972,185 teaches apparatus for applying material by cathodic arc vapor deposition to a substrate which includes a vessel, apparatus for maintaining a vacuum in the vessel, an annular cathode having a bore and evaporative surface extending between first and second end surfaces, apparatus for selectively sustaining an arc of electrical energy between the cathode and an anode, an apparatus for steering the arc around the evaporative surface. The apparatus for steering the arc is positioned within the cathode bore, and produces a magnetic field that runs substantially parallel to the evaporative surface.

Moreover U.S. Pat. No. 5,433,836 teaches an arc source macroparticle filter which includes a circular cathode for emitting particles and an extended cylindrical anode adjacent to an co-axial with cathode for accelerating the emitted particles. Toroids generate a magnetic field to define a continuous non-linear plasma duct for directing charged particles and separating therefrom undesirable larger particles. The duct is minimally non-linear to permit high rates of charged particle transmission. Arc source filter allows heating and/or the deposition of a variety of surface coatings to a workpiece.

Finally U.S. Pat. No. 5,827,590 illustrates a 90° filter where there is no duct present or the magnetic field is produced by a few turns of a field coil where particles may either leave the filter through the openings between turns of the field and/or reflect off the turns.

Freestanding designs with single coils has proposed by the prior art still have several disadvantages namely:

(i) the current through the filter coil must be high enough to obtain a magnetic induction B=10,000 Am or more to direct plasma particles through the magnetic duct;

(ii) high magnetic field in the magnetic duct demands high magnetic field in the plasma source to equalize the pressure of magnetic field in the source and in the duct;

(iii) high magnetic field in the plasma source leads to an instability of the cathode spot motion on the surface of the cathode;

(iv) the requirement for high magnetic field in the plasma source creates very complicated engineering problems to scale up the plasma source;

(v) there is a significant probability that a macroparticle will be reflected from the turn of the coil in the direction of the substrate.

Accordingly it is an object of this invention to provide a more efficient filter and method of macroparticle filtering. In particular it is an object of this invention to provide a freestanding design having more than one coil.

It is a further object of this invention to provide a freestanding two-coil design.

### SUMMARY OF THE INVENTION

It is an object of this invention to provide an arc source macroparticle filter comprising a cathode for emitting particles, an anode for accelerating said emitted particles, means for generating a magnetic field to define a continuous curved plasma stream for directing metal ions towards a substrate and separate therefrom undesirable macroparticles.

It is a further aspect of this invention to provide a nanostructure plasma source having a large water-cooled vacuum chamber with baffles to trap macroparticles and dimensions are larger than the dimensions of magnetic coils, a circular or rectangular cathode with magnetic coils for emitting particles and a cylindrical or parallelepiped anode adjacent to and co-axial with said cathode for accelerating emitted charged particles, whereby high current coils adjacent to said anode in said vacuum chamber generate a magnetic field to create a curved plasma stream for directed plasma particles and separating therefrom larger particles which travel between the turns of high current coils.

It is another aspect of this invention to provide a filter wherein at least one coil is connected with additional power supplies to said cathode so that at least one coil becomes a distributed accelerated or decelerated anode.

### BRIEF DESCRIPTION OF THE DRAWINGS

A detailed description of the preferred embodiments are provided herein below by way of example only and with reference to the following drawings, in which:

FIG. 1 is a prior art drawing of a 90° open architecture filter.

FIG. 2 is a schematic view of a first embodiment of the invention.

FIG. 3 is a schematic view of a second embodiment of the invention.

FIG. 4 is a schematic view of another embodiment of the invention.

FIG. 5 is a schematic view of a further embodiment of the invention.

In the drawings, preferred embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

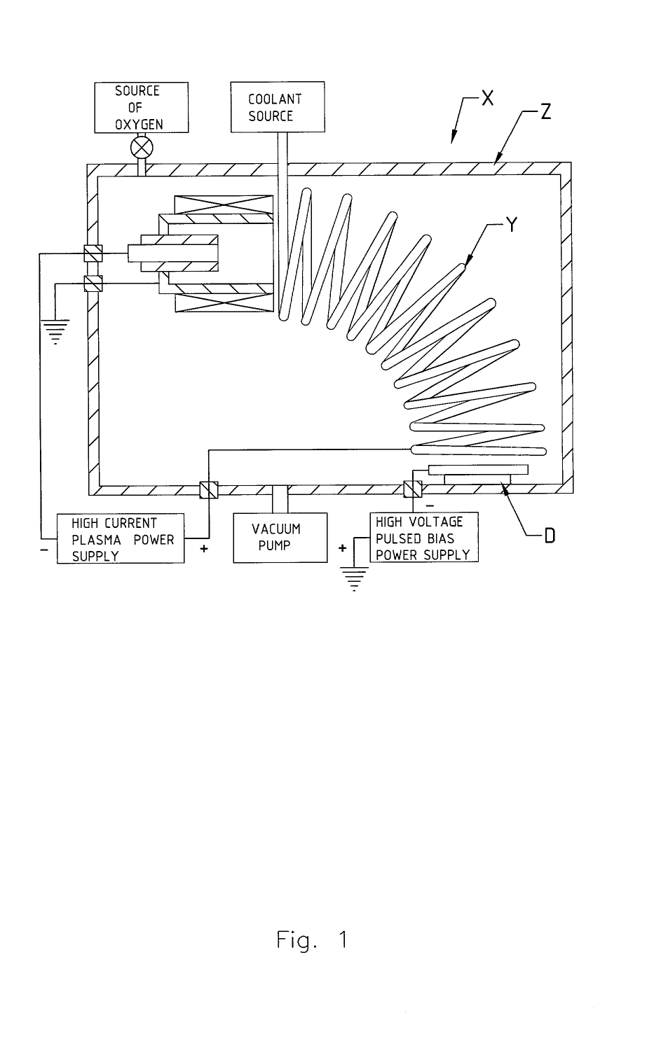

FIG. 1 illustrates a classic freestanding 90° filter, which has heretofore been used in the prior art.

In particular the classic 90° filter X includes a magnetic field coil Y generating a curved axial field within a deposition character Z.

Such classic 90° duct filters have macroparticles generated in the hot spot on the surface of the cathode, which travel at very high velocities along with the plasma and bounce or reflect off the duct walls onto the substrate D.

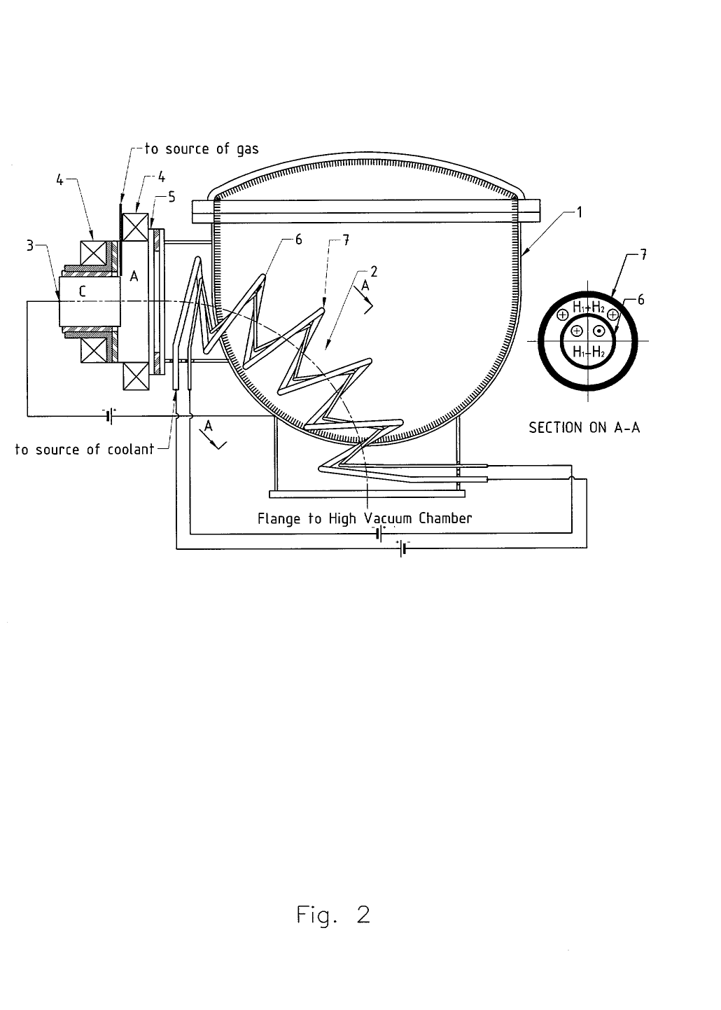

FIG. 2 generally describes one aspect of the invention herein.

In particular FIG. 2 shows the use of a freestanding two-coil design. FIG. 2 shows that magnetic generating means 10 are placed within a vacuum chamber 1 and comprise co-axial curved coils 6 and 7 to form a magnetic plasma corridor 2 to direct plasma particles onto a substrate and separate larger macroparticles travelling between the turns of the coils. Inside the external coil 7 there is another coil 6 substantially co-axial with the first coil 7 where the first coil 7 is larger in cross-section or diameter than the second coil 6. As shown in FIG. 2 the internal coil 6 has independent electrical connection and is isolated from the other wall 7.

Moreover FIG. 2 also shows an arc plasma source for deposition of nanostructure films and/or for plasma heating the workpiece, which includes a large water-cooled vacuum chamber 1 with walls to trap macroparticles, the chamber 1 having a linear size several times bigger than the dimension of magnetic coils 6 and 7, a circular or rectangular cathode 3 with emitting magnetic coils 4 for emitting particles and a cylindrical or parallelepiped anode 5 adjacent to and co-axial with the cathode 3 for accelerating and emitting charged particles. The substantially co-axial coils 6 and 7 generate a magnetic field to create a curved plasma corridor 2 for directing plasma particles and separating therefrom larger particles, which travel between the turns of coils 6 and 7. Inside the outer coil 7 there is another coil 6 substantially co-axial with the outer one and smaller in diameter. The internal coil 6 has independent electrical connection and is isolated from the external coil 7. The direction of electrical current or directions of turns in the external and internal coilsare opposite. The magnetic field in the space between two coils is the sum of the magnetic field from the external coil and the magnetic field from the internal coil. In the space of the inner coil 6 the magnetic field is the difference between the magnetic field from the external and internal coil. Motion of plasma is strongly effected by the magnetic field pressure which is equal to Pₘ=½ μ₀H². The magnetic field pressure between the coils can be easily made greater than the plasma pressure inside the inner coil ½ μ₀(H₁+H₂)²≧n·T. Therefore the space between the two coils becomes a magnet wall for plasma stream. This design creates a unique configuration for the plasma stream within the magnetic walls. The magnetic walls reflect plasma (and only plasma) particles and keep them inside the magnetic duct. To further eliminate macroparticle reflection from the turn of the coil the internal coil can be made from refractive conductive material and kept at high temperature. The coil temperature is higher than the saturated vapor temperature of the cathode material at the process pressure.

The cathode 3 is triggered to generate an arc producing a hot spot on the cathode 3 producing metal ion plasma as well as droplets of metal or macroparticles.

The magnetic coils 6 and 7 generate a magnetic field directing the stream of plasma having the metal ion plasma. The macroparticles are generally not affected by this magnetic field.

While the plasma stream can easily be bent, the relatively massive macroparticles move along almost straight trajectories.

The magnetic coils 6 and 7 are comprised of relatively thin size and large space between the turns of the coils 6 and 7. The walls of chamber 1 are water-cooled and comprise baffles 14 designed to trap the macroparticles that travel between the spaces between the coils 6 and 7 so as to trap the macroparticles from reflecting back unto the substrate.

The coils 12 illustrated herein are comprised of coil in the shape of spirals, a plurality of coils, or any other shape provided that the result includes the generation of a magnetic field which is utilized to separate and filter macroparticles from the metal iron plasma.

FIG. 2 therefore illustrates the first embodiment of the invention utilizing two substantially co-axial magnetic coils 6 and 7 which are substantially co-axially disposed relative to one another. The spiral coil 6 is co-axially disposed relative to the coil spiral 7 along curved axis 70 as illustrated in FIG. 2.

The electrical connection of the coils 6 and 7 may be selected so that the direction of the electrical current or the direction of turns in the first and second coils 6 and 7 are selected to produce magnetic fields which add to one another or tend to reduce the strength of one another. For example by viewing FIG. 2, the current through coil 6 is selected so that the magnetic field on the inside of the coil 6 is disposed in the direction shown and between the coils 6 and 7 in the direction of as shown. Likewise the coil 7 may be wound in a direction and connected so as to produce a magnetic field as shown on the inside of coil 7 and a magnetic field between the coils as shown in FIG. 2.

Accordingly the magnetic field on the inside of the coil 6 will be somewhat reduced by the opposite direction of the magnetic field from the coil 7 as shown in FIG. 2. Therefore the magnetic field inside the inner magnetic coil 6 will be the difference in the magnetic fields from the first and second coils 6 and 7. Therefore a smaller magnetic field will be produced inside the magnetic coil where the plasma flow will be produced and guided towards the substrate. The creation of a smaller magnetic field on the inside of the coil 6 results in a smaller resistance to the flow of plasma and it contributes to the increased plasma flow to the material.

On the other hand the magnetic field between the first and second magnetic coils 6 and 7 is close to the magnetic field produced by the external coil H₁, and therefore its pressure is greater than that inside the internal coil. This tends to produce a magnetic wall or shield tending to reflect the plasma (and only plasma) and keep them inside the magnetic field. The macroparticles on the other hand will travel in generally speaking along straight-line trajectories between the spaces of the first and second magnetic coils.

Therefore the magnetic field in the space between the two coils is the sum of the magnetic field from the first coil 6 and the weak external magnetic field from the second coil 7. In the space of the magnetic corridor i.e. insid the inner coil the magnetic field is the difference of the magnetic field from the first and second coils 6 and 7. Such a design creates a configuration for a plasma corridor with magnetic walls. The magnetic walls reflect the plasma particles and keep them inside the magnetic corridor. In order to reduce and substantially eliminate macroparticle reflection from the turns of the coils 6 and 7, the inner coil 6 is made of refractive or high temperature material and is kept at a high temperature.

In the case of heating the coil to a desirable temperature the temperature can be selected such that if a macroparticle does hit the surface of the coil such macroparticle will evaporate particularly when the temperature of the coil is selected to reach the saturated vapor temperature of the cathode material at the operating pressure of the plasma source.

Furthermore the coils 7 may be comprised of conductive material in the shape of a tube that is cooled by a flow of liquid or gas so as to control the temperature of the coil to a desirable level. By having the coil 7 within the chamber 1 heated to a desirable level and maintained at such desirable level by cooling a more efficient cathodic arc plasma deposition apparatus is described which is more stable and less prone to fluctuations.

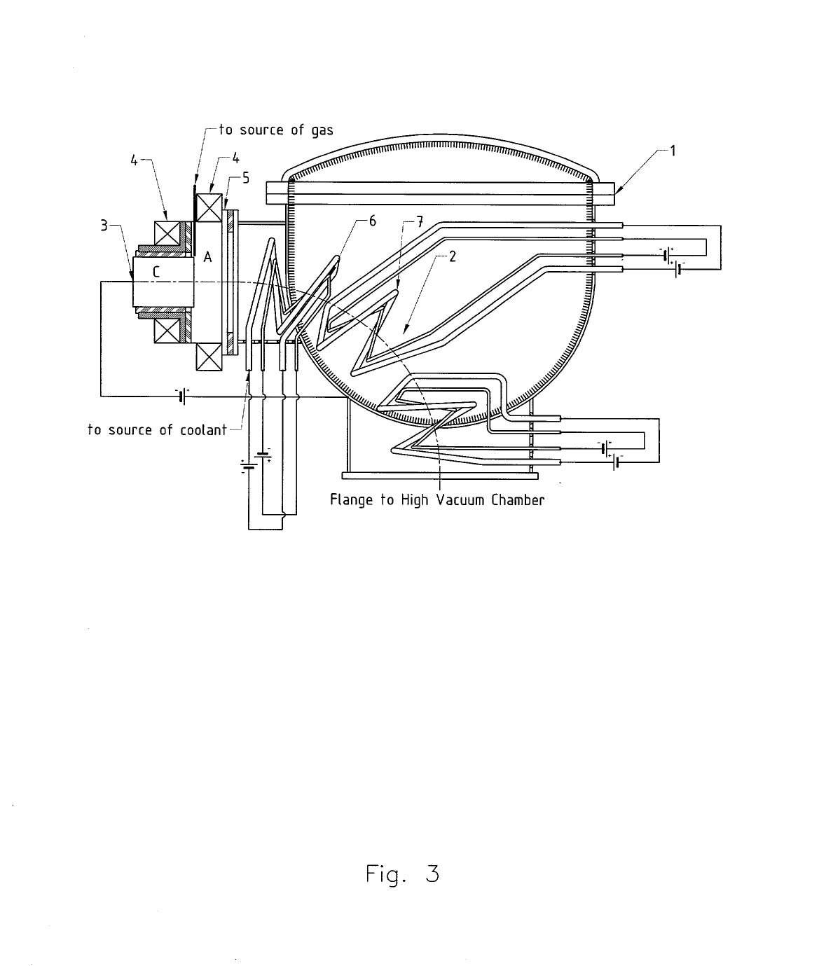

FIG. 3 illustrates another embodiment of the invention where the coil means 6 and 7 may be comprised of a plurality of substantially co-axial coils that are disposed about a common curved axis. In the embodiment shown in FIG. 3 there are three separate coils 6a 7a, 6b7b, 6c and 7c.

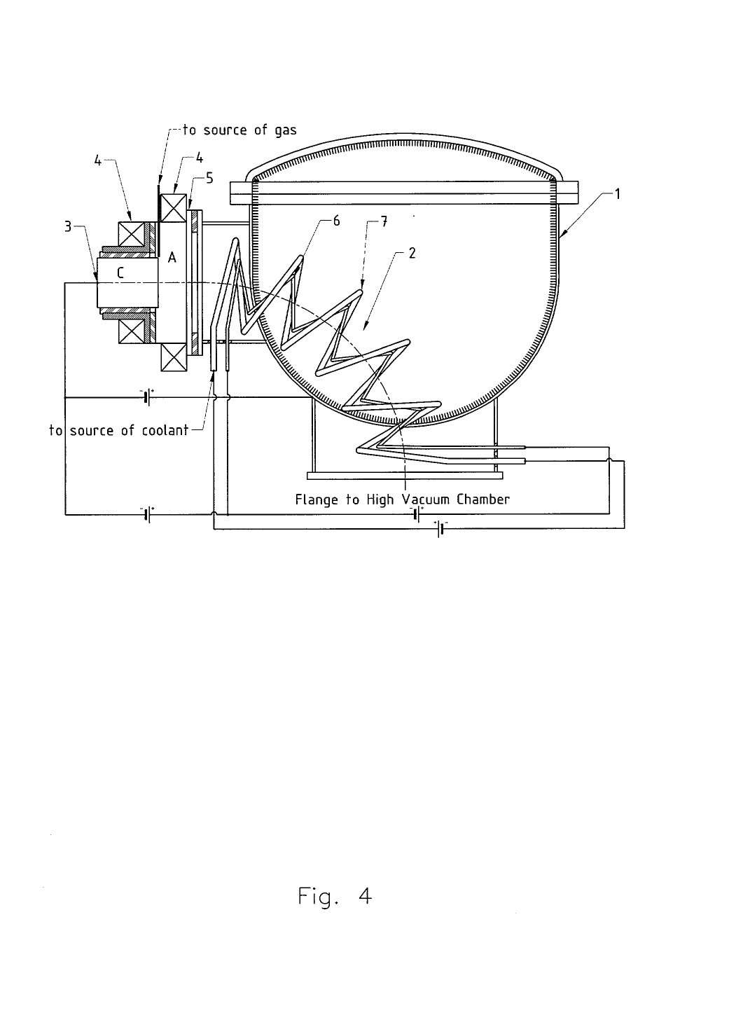

Alternatively FIG. 4 illustrates another embodiment where one end of the inner spiral 6 has an electrical connection as shown to the cathode. In this case the spiral coils 6 and 7 act as distributed accelerated or decelerated anodes depending on how they are connected. In other words, by connecting the coils 6 and 7 as shown in FIG. 4 the electrons in the plasma source or stream tend to accelerate since each subsequent or next turn of the coil is more positively charged than the one before it and accordingly the electrons accelerate as they get closer to the substrate on the exit of the nanostructure plasma source. This improves the efficiency, density and control of the plasma source.

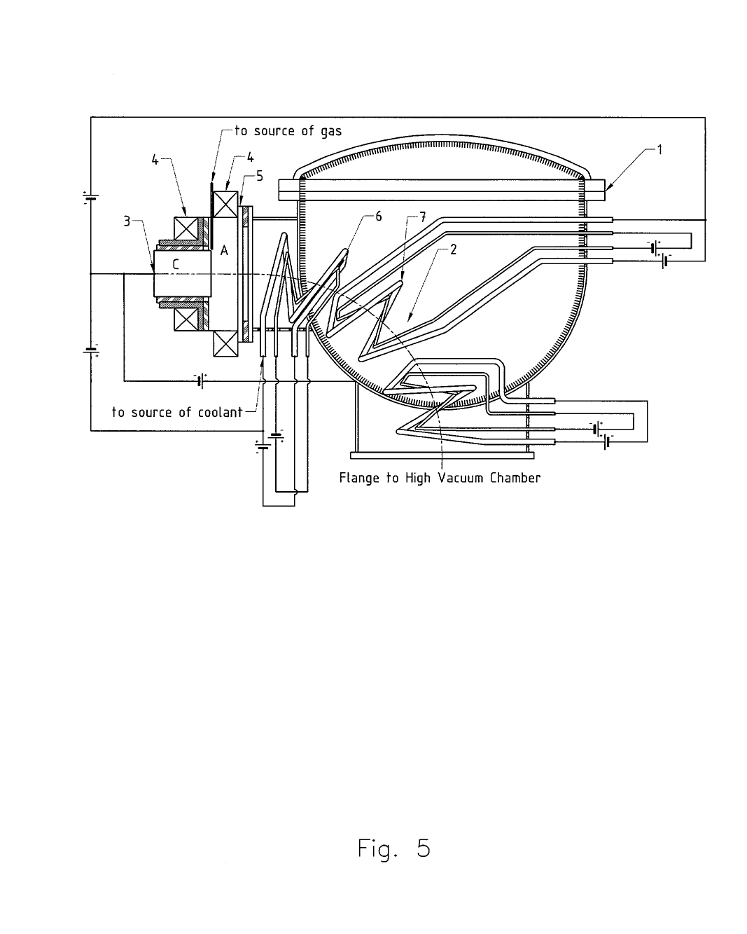

Another embodiment is shown in FIG. 5 where some of the plurality of coils 6a, 7a, 6b, 7b, 6c, 7c could be connected with additional power supplies to the cathode, in which case the connected coils become additional accelerating or decelerating anodes.

It should be noted that the improvements shown in FIGS. 3,4 and 5 can be experience when using only one spiral open architecture coil, namely:

1. one of the plurality of coils 6a, 6b, 6c or 7a, 7b, 7c could be used;

2. only one of the coils 6 or 7 could be used as shown in FIG. 4 and connected so as to accelerate the plasma flow;

3. only one of the plurality of coils 6a, 6b, 6c or 7a, 7b, 7c used as shown in FIG. 5 to accelerate and decelerate the plasma flow as required.

The configuration shown in FIG. 5 may also have the inner and outer magnetic coils connected with additional power supplies to the cathode as described in relation to FIG. 2 so as to produce accelerated or decelerated anodes.

I claim:

1. An arc source macroparticle filter comprising a cathode for emitting particles, an anode for accelerating said emitted particles, means for generating a magnetic field to define a continuous curved plasma stream for directing metal ions towards a substrate and separate therefrom undesirable macroparticles.

2. A plasma source having a large water-cooled vacuum chamber with baffles to trap macroparticles and dimensioned larger than the dimensions of magnetic coils, a circular or rectangular cathode with magnetic coils for emitting particles and a cylindrical or parallelepiped anode adjacent to and coaxial with said cathode for accelerating emitted charged particles, whereby high current coils adjacent to said anode in said vacuum chamber generate a magnetic field to create a curved plasma stream for directing plasma particles and separating therefrom larger particles which travel between the turns of high current coils.

3. A filter according to claim 1 wherein said means for generating a magnetic field comprises two coaxial spiral coils, where one end of each coil is adjacent and has an electrical connection on the side of anode and another end of the coil adjacent and has an electrical connection on the side of outlet of said filter.

4. A filter according to claim 1 wherein said means for generating a magnetic field comprises a plurality of magnetic coils where one of said coils is adjacent to and has two electrical connections to an anode and the last said coil is adjacent to and has two electrical connections on the outlet and in between there is at least one coil to generate a curved plasma stream where each of said at least one coil has two electrical connections.

5. A filter as claimed in claim 2 wherein said coils comprise a conductive tube cooled by flow of gas or liquid.

6. A filter as claimed in claim 3 wherein said coils comprise refractive conductive material kept at high temperature.

7. A filter as claimed in claim 5 wherein the temperature of the coil is higher than the temperature of the saturated vapor pressure of the cathode material at the operating pressure of plasma source and where said macroparticles emitted from the cathode that strike against a turn of said coils evaporate.

8. A filter as claimed in claim 1 wherein said means for generating a magnetic field comprises first and second substantially co-axially disposed spaced coils.

9. A filter as claimed in claim 8 wherein of one of said coils is smaller in diameter than said second coil.

10. A filter as claimed in claim 9 wherein both of said spiral coils can be cooled or can be kept at high temperature or one of the coils can be kept cool and another hot.

11. A filter as claimed in claim 8 wherein at least one coil is connected with additional power supplies to said cathode so that said at least once coil becomes a distributed accelerated or decelerated anode.

12. A filter as claimed in claim 4 wherein at least one of said plurality of coils are connected with additional power supplies to said cathode so that the connected coils become additional accelerated or decelerated anodes.

13. A method of filtering macroparticles from a plasma stream comprising:
(a) generating a plasma flow;
(b) directing the plasma flow towards a substrate by means of a magnetic field generated by magnetic coil means;
(c) said magnetic coil means generating a magnetic wall where
(i) macroparticles substantially pass through said magnetic wall and
(ii) said plasma is substantially contained and passed through said magnetic wall.
